(19) United States
(12) Patent Application Publication
(10) Pub. No.: US 2005/0172550 A1
(43) Pub. Date: Aug. 11, 2005

(54) Tree shelter

(75) Inventor: Carter Benson McCamy, Adamstown, MD (US)

Correspondence Address: NIXON & VANDERHYE, PC, 901 NORTH GLEBE ROAD, 11TH FLOOR, ARLINGTON, VA, 22203, US

(73) Assignee: Environmental Quality Resources, L.L.C., Gaithersburg, MD (US)

(21) Appl. No.: 11/027,688

(22) Filed: Jan. 3, 2005

Related U.S. Application Data
(60) Provisional application No. 60/534,201, filed on Jan. 2, 2004.

(51) Int. Cl. A01G 13/02

(52) U.S. Cl. 47/32.4

(57) ABSTRACT

A tree shelter includes a plurality of wooden stakes and a biodegradable yarn securing the wooden stakes in a side-by-side arrangement. The tree shelter is sized to encircle a tree to protect the tree from foraging animals.

### CROSS-REFERENCES TO RELATED APPLICATIONS

This application claims the benefit of U.S. Provisional Patent Application Ser. No. 60/534,201, filed Jan. 2, 2004, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates generally to landscaping apparatus and, more particularly, to a tree shelter formed of biodegradable materials for protecting newly planted trees.

Existing plant protectors are used to protect young trees and other types of plants from foraging animals, such as rabbits, rodents and deer. Rubbing by deer has become particularly problematic because of the dramatic increase in deer population in urbanized areas.

Conventionally, tree shelters formed of hydrocarbon-based plastic are placed around the base of a newly planted tree to serve as protection against foraging and rubbing. Hydrocarbon-based plastics, however, remain in the environment as inert, man-made products. Because the conventional shelters are not biodegradable, removal of the structure is required after the tree is established. As the tree grows, girdling of the trunk by a plastic tree shelter may prevent healthy growth of the tree.

### BRIEF SUMMARY OF THE INVENTION

The present invention proposes a tree shelter utilizing wooden stakes held together by a biodegradable yarn preferably made from a coir material. The term “wooden” as used herein encompasses wood materials of various types as well as woody materials such as bamboo. In an exemplary embodiment of the invention, a tree shelter includes a plurality of wooden stakes, and a biodegradable yarn securing the wooden stakes in a side-by-side arrangement. The tree shelter is sized to encircle a tree to protect the tree from foraging animals. In one arrangement, the wooden stakes each have a thickness of about ¼″. The shelter preferably has at least two spaced rows of the biodegradable yarn securing the wooden stakes in the side-by-side arrangement. In this context, the rows of biodegradable yarn are spaced away from ends of the wooden stakes. Moreover, a length of the biodegradable yarn may extend beyond an end of the side-by-side arrangement in each row, serving as ties for the tree shelter.

Preferably, the biodegradable yarn is formed of a coir material. At least one of the plurality of wooden stakes may be longer than the other wooden stakes to serve as a securing post. In this instance, an end of the longer wooden stakes may be sharpened. Still further, in an exemplary arrangement, the at least one longer wooden stake is about 48″ long, and the other wooden stakes are about 36″ long. Also in an exemplary arrangement, the side-by-side arrangement is about 18″ wide.

Preferably, the wooden stakes are formed of bamboo.

In another exemplary embodiment of the invention, a tree shelter includes a plurality of wooden stakes arranged in a side-by-side arrangement, at least one of the wooden stakes being longer than the others to serve as a securing post. The wooden stakes are held in the side-by-side arrangement by a biodegradable yarn knotted to adjacent stakes.

In yet another exemplary embodiment of the invention, a method of assembling the tree shelter includes aligning a plurality of wooden stakes in a side-by-side arrangement; and securing the wooden stakes in the side-by-side arrangement using a biodegradable yarn, wherein a number of the wooden stakes is selected so that the tree shelter is sized to encircle a tree to protect it from foraging animals.

### BRIEF DESCRIPTION OF THE DRAWINGS

These and other aspects and advantages of the present invention will be described in detail with reference to the accompanying drawings, in which:

FIG. 1 shows the tree shelter of the present invention prior to installation; and

FIG. 2 shows the tree shelter in an exemplary installation protecting a newly planted tree.

### DETAILED DESCRIPTION OF THE INVENTION

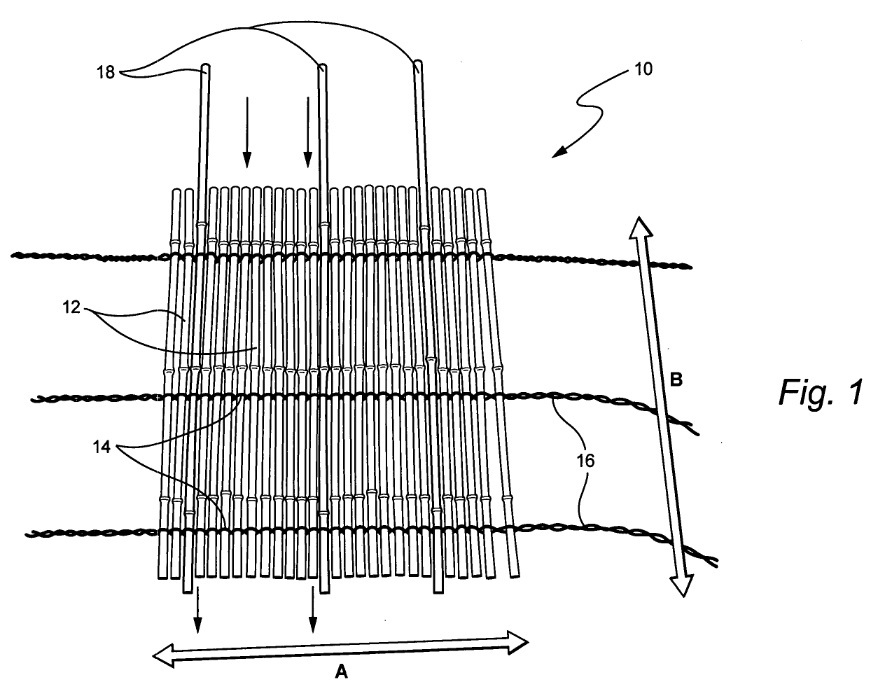

With reference to FIG. 1, the tree shelter 10 includes a plurality of wooden stakes 12 and a biodegradable yarn 14 preferably formed of a coir material that secures the wooden stakes 12 in a side-by-side arrangement as shown. The term “wooden” as used herein encompasses wood materials of various types as well as woody materials such as bamboo. The number of wooden stakes 12 is dependent on a thickness of the tree to be sheltered, but a preferred width (see arrow A in FIG. 1) of the side-by-side arrangement is about 18 inches, which includes about 30 wooden stakes each having a thickness of about ¼ inch.

The coir yarn 14 is tightly knotted to each of the wooden stakes 12. The knotting can be performed using any known manual or automated process. Three rows of coir yarn 14 are shown in FIG. 1, although more or fewer may be suitable. The coir yarn 14 is preferably positioned away from ends of the stakes 12 to avoid rot. A length of the coir yarn extends beyond ends of the assembled stakes 12 to serve as ties 16 for the assembly.

One or more, preferably three, of the wooden stakes 12 are longer than the other wooden stakes to serve as securing posts 18 to be driven into the ground to support the assembly (see FIG. 1). The securing posts 18 are preferably about ⅓ longer than the other wooden stakes 12. To facilitate insertion into the ground, ends of the securing posts 18 may be sharpened.

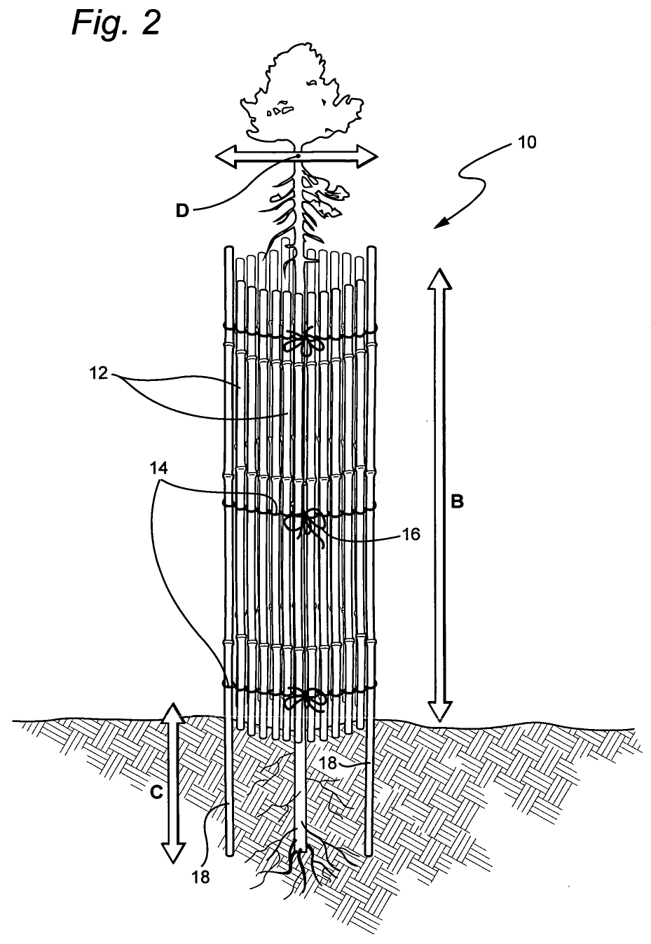

In an exemplary arrangement, the wooden stakes 12 are about 36 inches in length (see arrow B in FIGS. 1 and 2), and the securing posts 18 are about 48 inches in length—arrow C in FIG. 2 shows the securing posts 18 extending about 12 inches into the ground. With the side-by-side arrangement spanning a width of about 18 inches (arrow A in FIG. 1), the resulting assembled thickness is slightly less than 6 inches (see arrow D in FIG. 2).

The structure of the tree shelter according to the present invention yields a tree shelter formed entirely of biodegradable materials. The wooden stakes are sturdy enough to provide adequate protection of the tree against foraging animals without requiring removal of the structure after the tree or other planting is established. Moreover, girdling of the trunk is avoided, thereby promoting healthy growth of the tree.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A tree shelter comprising:
a plurality of wooden stakes;
a biodegradable yarn securing the wooden stakes in a side-by-side arrangement, wherein the tree shelter is sized to encircle a tree to protect the tree from foraging animals.

2. A tree shelter according to claim 1, wherein the wooden stakes each have a thickness of about ¼″.

3. A tree shelter according to claim 1, comprising at least two spaced rows of the biodegradable yarn securing the wooden stakes in the side-by-side arrangement.

4. A tree shelter according to claim 3, wherein the rows of biodegradable yarn are spaced away from ends of the wooden stakes.

5. A tree shelter according to claim 3, wherein a length of the biodegradable yarn extends beyond an end of the side-by-side arrangement in each row, serving as ties for the tree shelter.

6. A tree shelter according to claim 1, wherein the biodegradable yarn is formed of a coir material.

7. A tree shelter according to claim 1, wherein at least one of the plurality of wooden stakes is longer than the other wooden stakes to serve as a securing post.

8. A tree shelter according to claim 7, wherein an end of the longer wooden stakes is sharpened.

9. A tree shelter according to claim 7, wherein the at least one longer wooden stake is about 48″ long, and wherein the other wooden stakes are about 36″ long.

10. A tree shelter according to claim 1, wherein the side-by-side arrangement is about 18″ wide.

11. A tree shelter according to claim 1, wherein the wooden stakes are formed of bamboo.

12. A tree shelter comprising a plurality of wooden stakes arranged in a side-by-side arrangement, at least one of the wooden stakes being longer than the others to serve as a securing post, the wooden stakes being held in the side-by-side arrangement by a biodegradable yarn knotted to adjacent stakes.

13. A tree shelter according to claim 12, comprising at least two spaced rows of the biodegradable yarn securing the wooden stakes in the side-by-side arrangement.

14. A tree shelter according to claim 13, wherein the rows of biodegradable yarn are spaced away from ends of the wooden stakes.

15. A tree shelter according to claim 13, wherein a length of the biodegradable yarn extends beyond an end of the side-by-side arrangement in each row, serving as ties for the tree shelter.

16. A tree shelter according to claim 12, wherein the biodegradable yarn is formed of a coir material.

17. A tree shelter according to claim 12, wherein the side-by-side arrangement is about 18″ wide.

18. A tree shelter according to claim 12, wherein the wooden stakes are formed of bamboo.

19. A method of assembling a tree shelter, the method comprising:
aligning a plurality of wooden stakes in a side-by-side arrangement; and
securing the wooden stakes in the side-by-side arrangement using a biodegradable yarn,
wherein a number of the wooden stakes is selected so that the tree shelter is sized to encircle a tree to protect it from foraging animals.
